(19) United States
(12) Patent Application Publication
(10) Pub. No.: US 2019/0277304 A1
(43) Pub. Date: Sep. 12, 2019

(54) PROCESS FOR CALCULATING AN ANGULAR SPACING BETWEEN THE BLADES OF AN AXIAL FAN

(71) Applicant: SPAL AUTOMOTIVE S.r.l., Correggio (RE) (IT)

(72) Inventor: Pietro DE FILIPPIS, Varazze (IT)

(21) Appl. No.: 15/774,542

(22) PCT Filed: Nov. 18, 2016
(86) PCT No.: PCT/IB2016/056964

§ 371 Date: May 8, 2018

(30) Foreign Application Priority Data
Nov. 19, 2015 (IT) 102015000074573

(51) Int. Cl. F04D 29/32; F04D 29/66; G06F 17/50

(52) U.S. Cl. CPC F04D 29/328; G06F 2217/16; G06F 17/50; F04D 29/666

(57) ABSTRACT

A process for calculating an angular spacing of an axial fan including a hub and a number z of blades extending from the hub wherein an angular position of the various blades is indicated as α₁, . . . , αa_{z} assuming α₁=0, and an angular difference between the various blades is indicated as εᵢ=αᵢ₊₁−αᵢ, i=1, . . . , z−1, ε_{z}=360°−α_{z}, including a step of setting up a calculating system including a plurality of mathematical problems each an expression of a constraint which the angular spacing must satisfy; the calculating system including a first mathematical problem which requires that the fan is statically balanced, a second mathematical problem which requires that adjacent blades are not superposed and a third mathematical problem which requires that the angular differences ε₁, . . . , εₙ are all different to each other.

### TECHNICAL FIELD

This invention relates to a process for calculating an angular spacing, in particular a process for calculating or a method for designing the angular spacing between the blades of an axial flow fan or an axial fan.

### BACKGROUND ART

The axial fans in question are those designed for automotive applications and in particular for engine cooling systems generally in combination with a suitable heat exchanger, for example a radiator.

The fans of this type must meet several requirements, including high efficiency, dimensional compactness, in particular in an axial direction, capacity to achieve good head (pressure) and flow rate values and low noise.

The techniques for angular spacing between the blades of an axial fan have evolved over time.

The embodiment of a fan has in effect, in theory, infinite solutions which are reduced by imposing, in a complex system of equations, opportune constraint conditions; one constraint condition, for example, which must always be complied with is that the fan is balanced.

Patent EP0553598B, in the name of the same Applicant as this invention, illustrates a fan equipped with blades with blades spaced at equal angles.

Fans manufactured in accordance with this patent give good efficiency and low sound level values, however the sound distribution of the noise can prove to be disturbing for human hearing.

In effect, with the blades spaced at equidistant angles a resonance phenomena occurs with a series of harmonics whose frequency corresponds to a whole multiple of the blade passage frequency. This frequency corresponds to the product of the number of revolutions per second of the fan and the number of blades. These resonance phenomena cause a hissing noise which can prove to be annoying for human hearing.

Even though the perception of discomfort caused by a noise is mainly a subjective issue, there are substantially two factors which influence the sound disturbance: the sound pressure level, that is, the intensity of the noise and its tonal distribution. Noises even with a small intensity can therefore be annoying if the tonal distribution of the noise distinguishes it from the background noise; for example, a tone is considered to be annoying when it is at least 6 dB greater than the base level of the noise (broad band).

In order to overcome this drawback, fans have been proposed with the blades spaced at non-equal angles also to avoid the tones determined by the presence of aeraulic discontinuities affecting the flow of air; an example of such fans is described in patent EP0945625 in the name of the same Applicant.

By calculating the integral of the sound intensity values at the various frequencies (overall noise), a noise is produced with the blades spaced at unequal angles which is approximately equal to the noise with the blades spaced at equal angles. However, the different tonal distribution of the noise allows an improvement of the acoustic comfort.

The logic of offsetting the blades has developed into sophisticated logics translated into corresponding constraint conditions increasingly aimed at improving the perceived noise on the basis of the spectrum of sound emissions.

However, types of perceived noise exist which are not visible in the spectrum and which cause an unpleasant sensation.

Quite the contrary, there are cases of fans with an acceptable or god spectrum which nevertheless transmit, in use, an unpleasant sensation.

In this context, the main purpose of this invention is to provide a process for calculating the angular spacing which overcomes the above-mentioned disadvantages.

### DISCLOSURE OF THE INVENTION

The aim of this invention is to provide a process for calculating the angular spacing in an axis fan which translates into an implementation of a type of fan having improvements in terms of noise and in particular of perceived noise in such a way as to make the noise generated in rotation as pleasant as possible.

The technical purpose indicated and the aims specified are substantially achieved by a calculating process according to claim 1.

### BRIEF DESCRIPTION OF DRAWINGS

Further features and advantages of the invention are more apparent in the detailed description below, with reference to a preferred, non-limiting, embodiment of a process for calculating an angular spacing between the blades of an axial fan of the type illustrated in the accompanying drawings, in which:

FIG. 1 illustrates a schematic plan view of an axial fan calculated with the process according to this invention;

FIG. 2 illustrates a schematic plan view of a second embodiment of an axial fan calculated with the process according to this invention.

### DETAILED DESCRIPTION OF PREFERRED EMBODIMENTS OF THE INVENTION

With reference to the accompanying drawings, the numeral 1 denotes an axial fan in relation to which short definitions are provided below of the terms used to describe the process according to this invention:

the blade spacing angle α is the angle measured at the centre of rotation between the radii passing at corresponding points of each blade, for example an edge of the end of the blades; each spacing angle α corresponds to an angular position where, for convenience, α₁=0

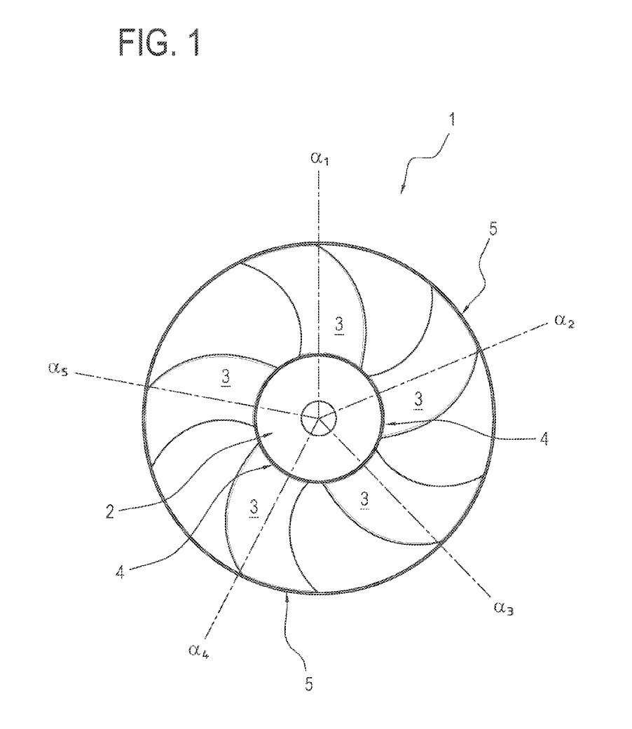

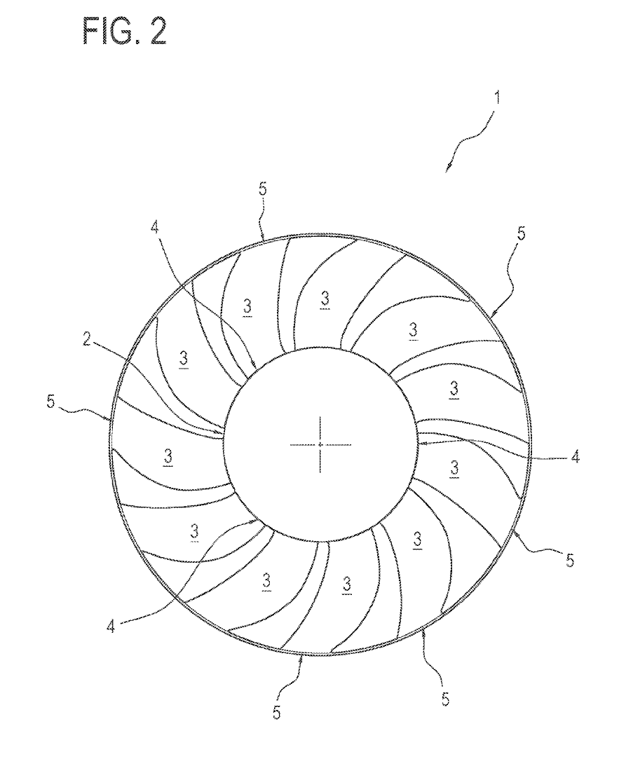

The fan 1 illustrated by way of an example in FIG. 1 comprises a hub 2 from which extend five blades 3 whilst the fan of FIG. 2 comprises eleven blades; the number of blades 3 of the fan 1 are labelled below as “z”.

Each blade 3 has a root 4 and an apex or end 5 and is formed by a series of aerodynamic profiles, in theory one for each radial cross-section of the blade, which are joined progressively starting from the root 4 at end 5.

An angular difference between the various blades is indicated as:

εᵢ=αᵢ₊₁−αᵢ, i=1, . . . , z−1, ε_{z}=360 °−α_{z}

The process for calculating the angular spacing comprises a step of setting up a system comprising a plurality of mathematical problems each an expression of a constraint or condition which the angular spacing must satisfy.

In a preferred embodiment, the system comprises a first mathematical problem which requires that the fan 1 is statically balanced.

$$\{ \begin{matrix}{\sum }_{i = 1}^{z} cos {α}_{i} = 0 \\ {\sum }_{i = 1}^{z} sin {α}_{i} = 0\end{matrix}$$

In the case in the example in FIG. 1 of fan 1 with five blades:

$$\{ \begin{matrix}cos {α}_{1} + cos {α}_{2} + cos {α}_{3} + cos {α}_{4} + cos {α}_{5} = 0 \\ sin {α}_{1} + sin {α}_{2} + sin {α}_{3} + sin {α}_{4} + sin {α}_{5} = 0\end{matrix}$$

Taking into account that αᵢ=0 gives:

$$\{ \begin{matrix}1 + cos {α}_{2} + cos {α}_{3} + cos {α}_{4} + cos {α}_{5} = 0 \\ sin {α}_{2} + sin {α}_{3} + sin {α}_{4} + sin {α}_{5} = 0\end{matrix}$$

Replacing as the unknown of the problem the angular differences gives the following three equations:

$$\{ \begin{matrix}1 + cos {ɛ}_{1} + cos ( {ɛ}_{1} + {ɛ}_{2} ) + cos ( {ɛ}_{1} + {ɛ}_{2} + {ɛ}_{3} ) + cos ( {ɛ}_{1} + {ɛ}_{2} + {ɛ}_{3} + {ɛ}_{4} ) = 0 \\ sin {ɛ}_{1} + sin ( {ɛ}_{1} + {ɛ}_{2} ) + sin ( {ɛ}_{1} + {ɛ}_{2} + {ɛ}_{3} ) + sin ( {ɛ}_{1} + {ɛ}_{2} + {ɛ}_{3} + {ɛ}_{4} ) = 0 \\ {ɛ}_{5} = 360 ° - ( {ɛ}_{1} + {ɛ}_{2} + {ɛ}_{3} + {ɛ}_{4} )\end{matrix}$$

that is, a system of three equations with five unknowns and two degrees of freedom; in general, for a fan with z blades a system is obtained from the balancing condition of three equations with z unknowns, that is, a system with z-3 degrees of freedom.

A solution of the system is obtained by calculating the angular positions:

$$\{ \begin{matrix}{α}_{1} = 0 \\ {α}_{2} = {ɛ}_{1} \\ {α}_{3} = {ɛ}_{1} + {ɛ}_{2} \\ {α}_{4} = {ɛ}_{1} + {ɛ}_{2} + {ɛ}_{3} \\ {α}_{5} = {ɛ}_{1} + {ɛ}_{2} + {ɛ}_{3} + {ɛ}_{4}\end{matrix}$$

The system set up in the calculation process comprises a second mathematical problem which requires that adjacent blades are not superposed.

Introducing an angle δ which takes into account the “angular extension” of the blade 3 to the hub 2, so as not to have superposing of the blades, it is necessary that:

εᵢ≥δi=1, . . . , z

In the case in the example of fan 1 with five blades 3 it is possible to write:

ε₁≥δε₂≥δε₃≥δε₄≥δε₅≥δ

This condition allows the moulding of the fan from plastic material since the non-superposing of the blades 3 allows the opening of the mould, which is otherwise problematic.

In the calculation process according to the invention, the calculation system comprises a third mathematical problem which requires that the angular differences ε₁, . . . , εₙ between the blades 3 are all different to each other.

In this way, in use, the effects which there would be in the presence of several pairs of blades spaced by the same angle are annulled.

In that case, there would be two systems which generate identical harmonic content at low frequency, that is, sound pressure waveforms with the same harmonic contents. The Applicant has observed that these circumstances lead to the so-called “rattle noise”, which is an example of perceived noise not visible in the spectrum which causes an unpleasant sensation but which is eliminated by imposing angular differences between the blades which are all different to each other.

In a preferred embodiment, so as not to have pairs of blades with equal angular difference the following condition is specified:

|εᵢ−εⱼ|≥λ°i≠j, i=1, . . . , z, j=1, . . . , z, λ>0

in one embodiment it is, for example, λ=2

In the case in the example of fan 1 with five blades 3, considering for example λ=2 it is possible to write:

|ε₁−ε₂|≥2°|ε₁−ε₃|≥2°|ε₁−ε₄|≥2°|ε₁−ε₅|≥2°

|ε₂−ε₃|≥2°|ε₂−ε₄|≥2°|ε₂−ε₅|≥2°

|ε₃−ε₄|≥2°|ε₃−ε₅|≥2°|ε₄−ε₅|≥2°

In the calculation process according to the invention, the calculation system comprises a fourth mathematical problem which requires an absence of blades offset by 180°, that is:

αᵢ−αⱼ≠180°i>j, i=1, . . . , z, j=1, . . . , z

Advantageously, this condition avoids that, for reasons of symmetry of the application wherein the fan 1 is installed, there is simultaneous generations of a same noise, that is to say, so as not to have two blades which generate the same noise at the same time, there must not be diametrically opposite blades which would encounter threads air having the same shape.

The process according to the invention therefore checks all the above-mentioned conditions and, for each solution found, evaluates a target function ƒ(εᵢ) defined as follows:

ƒ(ε₁)=(ε₁−ε₂)²+(ε₁−ε₃)²+(ε₁−ε₄)²+(ε₁−ε₅)²++(ε₂−ε₃)²+(ε₂−ε₄)²+(ε₂−ε₅)²+(ε₃−ε₄)²+(ε₃−ε₅)²+(ε₄−ε₅)²

In general, the target function can be expressed as follows:

$$f ( {ɛ}_{i} ) = \frac{1}{2} {\sum }_{i , j = 1}^{z} {( {ɛ}_{i} - {ɛ}_{j} )}^{2}$$

The calculation process comprises of maximising the above-mentioned target function so as to have angular differences as different as possible to each other.

In a preferred embodiment, once the angular differences ε are calculated, the geometry of the blades, which is identical for all the blades 3, which are offset according to the angles calculated, is determined in known fashion.

In practice, a fan 1 is obtained with identical vanes 3 offset from each other by the angles calculated, illustrated for example in FIG. 1.

In another preferred embodiment, illustrated in FIG. 2, the blades 3 are each generated with the so-called “edge bow’ different from the others.

In practice, the blades 3 are generated with edge bows differentiated blade by blade and they are not identical with each other.

Preferably, the blades 3 are generated in such a way as to have the profiles at the hub 2, that is, at the root 4, equispaced, that is, separated by angles all equal to each other, whilst the profiles at the apex 5 are spaced by the angles ε as calculated.

In practice, in this case, one starts with a blade geometry, generated in a substantially known manner, which already has an edge bow angle, that is to say, a sweep angle, which identifies how much the profile of the apex is rotated relative to that at the hub or at the root.

The angles ε calculated as described above are added to the initial edge bow and the blades therefore each have an edge bow different from the others.

The invention described brings important advantages.

The embodiment of axial fans has in theory infinite solutions which are reduced with the more constraints it is possible to impose to reduce the number of variables in question.

The proposed calculation system based on a plurality of problems, in the sense of problems which require the determination or the construction of one or more entities (numbers, functions, geometrical figures, sets, etc.) which satisfy conditions specified in the terms of the problem, allows the degrees of freedom of the calculation process to be reduced.

The proposed design method allows a significant reduction in the so-called “rattle noise” to be obtained and in general an improvement of the performance of the fan in terms of perceived noise.

1. A process for calculating an angular spacing of an axial fan comprising a hub and a number z of blades extending from the hub, each blade having a root and an apex and being formed by a plurality of aerodynamic profiles which are joined progressively starting from the root to the end, an angular position of the various blades being indicated as
α₁, . . . , α_{z} assuming α₁=0,
an angular difference between the various blades being indicated as
εᵢ=αᵢ₊₁−αᵢ, i=1, . . . , z−1, ε_{z}=360 °−α_{z}
the process comprising
a step of setting up a calculation system comprising a plurality of mathematical problems each an expression of a constraint which the angular spacing must satisfy, the calculation system comprising
a first mathematical problem which requires that the fan is statically balanced and
a second mathematical problem which requires that adjacent blades are not superposed,
the process wherein the calculation system comprises a third mathematical problem which requires that the angular differences ε₁, . . . , εₙ are all different to each other.

2. The process according to claim 1, wherein the third mathematical problem is of the type:

|εᵢ−εⱼ|≥λ°i≠j, i=1, . . . , z, j=1, . . . , z

3. The process according to claim 1, wherein the calculation system comprises a fourth mathematical problem which requires an absence of blades which are offset by 180°, that is to say:
∝ᵢ−∝ⱼ≠180°i>j, i=1, . . . , z, j=1, . . . , z

4. The process according to claim 1, comprising a step of calculating a target function of the type:
$$f ( {ɛ}_{i} ) = \frac{1}{2} {\sum }_{i , j = 1}^{z} {( {ɛ}_{i} - {ɛ}_{j} )}^{2}$$
for each solution of the calculation system, and a step of maximising the target function to have angular differences
εᵢ=αᵢ₊₁−αᵢ, i=1, . . . , z−1, ε_{z}=360 °−α_{z}
as different as possible to each other.

5. The process according to claim 1, comprising a step for generating a blade geometry which is equal for all the blades and a step of offsetting the blades according to the angular differences ε₁, . . . , εₙ.

6. The process according to claim 1, comprising a step for generating a blade geometry wherein the profiles at the hub, that is, at the root, are equally spaced and the profiles at the apex are spaced according the angular differences ε₁, . . . , εₙ.

7. The process according to claim 6, wherein the step for generating the geometry of the blade comprises a step for generating an edge-bow blade geometry having a edge bow angle which identifies how much the profile of the apex is rotated relative to the profile at the root and a step of addition to the edge-bow angle of the angular differences ε₁, . . . , εₙ, the blades having edge bows different from each other.
